(19) United States
(12) Patent Application Publication
(10) Pub. No.: US 2004/0136831 A1
(43) Pub. Date: Jul. 15, 2004

(54) Weight reduced steam turbine blade

(76) Inventors: Kevin J. Barb, Halfmoon, NY (US); Douglas C. Hofer, Clifton Park, NY (US)

Correspondence Address: J. Joseph Muller, Polster, Lieder, Woodruff & Lucchesi, L.C., Suite 230, 763 South Ballas Road, St. Louis, MO, 63141-8750, US

(21) Appl. No.: 10/339,535

(22) Filed: Jan. 9, 2003

(51) Int. Cl. F03B 3/12

(52) U.S. Cl. 416/231 R

(57) ABSTRACT

A blade (10) used in a steam turbine has a base (12) for attaching the blade to a hub (H), the blade extending radially outwardly from the hub to a distal, tip end (16). A plurality of holes (H1-Hn) extend a predetermined distance inwardly from the tip end of the blade into the body (18) of the blade. The holes are spaced across a chord (C) of the blade with the number of holes, their individual diameters, and their spacing being a function of the desired mass of the blade, local stress patterns formed at the tip end of the blade, the range of operating speeds of the turbine, vibrations and resonant frequencies created within the turbine, and a minimum wall thickness between the hole and sides (S1, S2) of the blade. The holes reduce the mass of the blade and lessen the forces to which the blade is subjected when the blade is rotating.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to the construction of blades (buckets) used in a steam turbine; and more particularly, to weight reduction in the blades used in the latter stages of a turbine.

Steam expands as it flows through the various stages of a turbine engine. Because of this, the turbine blades installed in the latter stages of the turbine are longer than those installed in the earlier stages of the engine. These longer blades are subjected to high centrifugal loads. The centrifugal force (operating load) to which a blade is subjected is given by the formula

F=MRω²

where M is the mass of the blade

R is the radius of the blade center of mass (the distance from the centerline of the turbine to where the mass is located), and

ω is the rotating speed of the blade.

Those skilled in the art will understand that the bucket is subjected to both a static stress (which occurs when the turbine is operating at speeds on the order of 3000-3600 rpm, its normal operating range), as well as alternating stresses caused by vibrations within the turbine, and resonance. As the mass of the blade increases (and correspondingly the load on the blade), its cross-sectional area must also increase (at the lower radii of the blade), so the blade can support the mass above it without exceeding the allowable stress on the material from which the blade is fabricated. The increasing cross-sectional area, at lower spans of the blade, causes excessive steam flow blockage at the root of the blade and higher stress on the hub disks. Ultimately, these conditions reduce the reliability and performance of the turbine.

One way to enhance blade performance and prevent the failure of blades used in the last stage of the engine is to reduce the mass of the blade.

One method currently used to reduce weight of steam turbine buckets is shown in FIG. 1. To reduce the mass of the blade, one or more holes are drilled from the root of the blade, where it mounts to a hub, longitudinally of the blade into the body of the blade. In FIG. 1, a blade B has a base or root section R by which the blade is mounted on a hub H of the last stage of the turbine. A hole L is formed or drilled into the base of the blade and extends upwardly a distance D into the body of the blade. Although only one hole is shown in FIG. 1, there may be a number of holes. While this approach does reduce the mass of the bucket and thereby addresses the problems discussed above, there are other, more effective ways of making the blade which provide other advantages as well.

### BRIEF SUMMARY OF THE INVENTION

Briefly stated, the present invention includes an improved blade for installation in a turbine engine. During manufacture of the blade, a plurality of holes are drilled into the blade, at the tip end of the blade. The holes extend across the blade from one side to the other and are formed at spaced intervals along the chord of the blade. The holes are dead ended holes and their length is determined as a function of the manufacturing equipment used to make the blade, the wall thickness at the tip end of the blade, and the resulting stress patterns in the blade. When installed on a hub and operating at nominal turbine engine speeds, the reduced mass of the blade lessens the amount of loading to which the blade is subjected, thereby allowing for either a reduced cross-sectional area at the root of the blade (which improves engine performance), or reduced attachment stress (which improves reliability), or both.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a cross-sectional view of the root end of a turbine blade illustrating a prior art method of manufacture of the blade by which the mass of the blade is reduced;

FIG. 2 is a perspective view of a turbine blade of the present invention with a weight reduced tip;

FIG. 3A is an elevation view of the blade of FIG. 2; and,

FIG. 3B is an enlarged view of the tip end of the blade illustrating holes formed in the tip to reduce the weight of the blade.

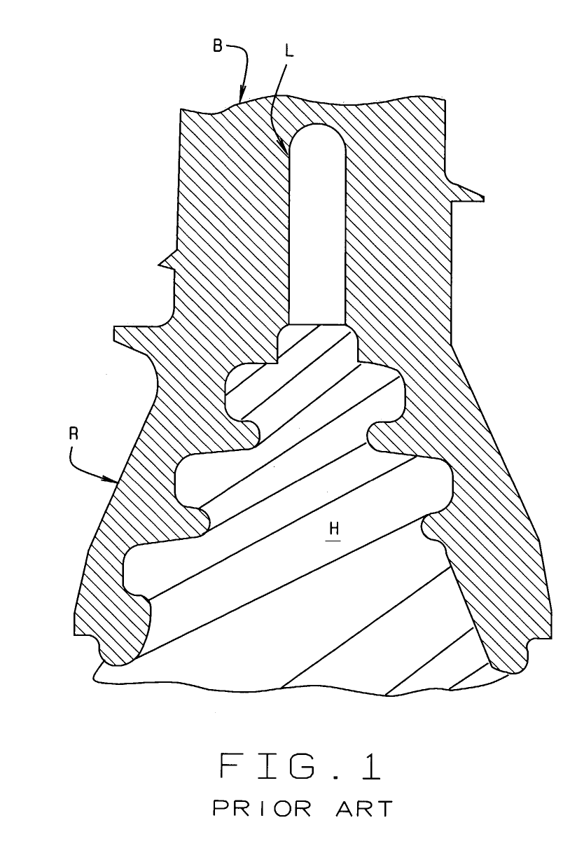

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

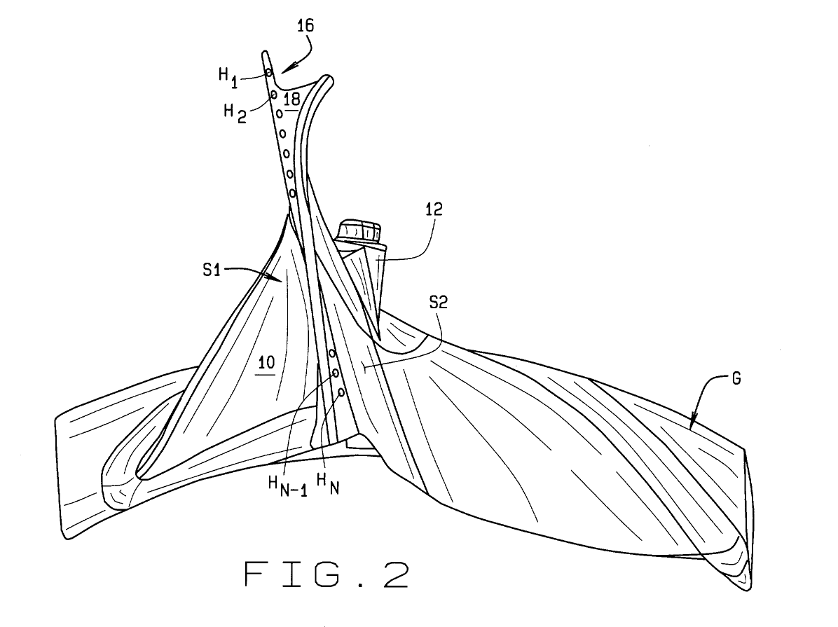

Referring to FIG. 2, a weight reduced blade of the present invention is indicated generally 10. Blade 10 is for use in a steam turbine, and more particularly in the last stage of the turbine. It is in this stage where the centrifugal load to which the blade is subjected during operation of the turbine is the highest. Those skilled in the art understand that a turbine is comprised of a series of stages and while blade 10 of the present invention is for use in the last stage, it could also be used in other stages of the turbine without departing from the scope of the invention. It will also be understood that while the following description is with respect to only one blade, each blade comprising a stage of the turbine employs a plurality of identically formed blades.

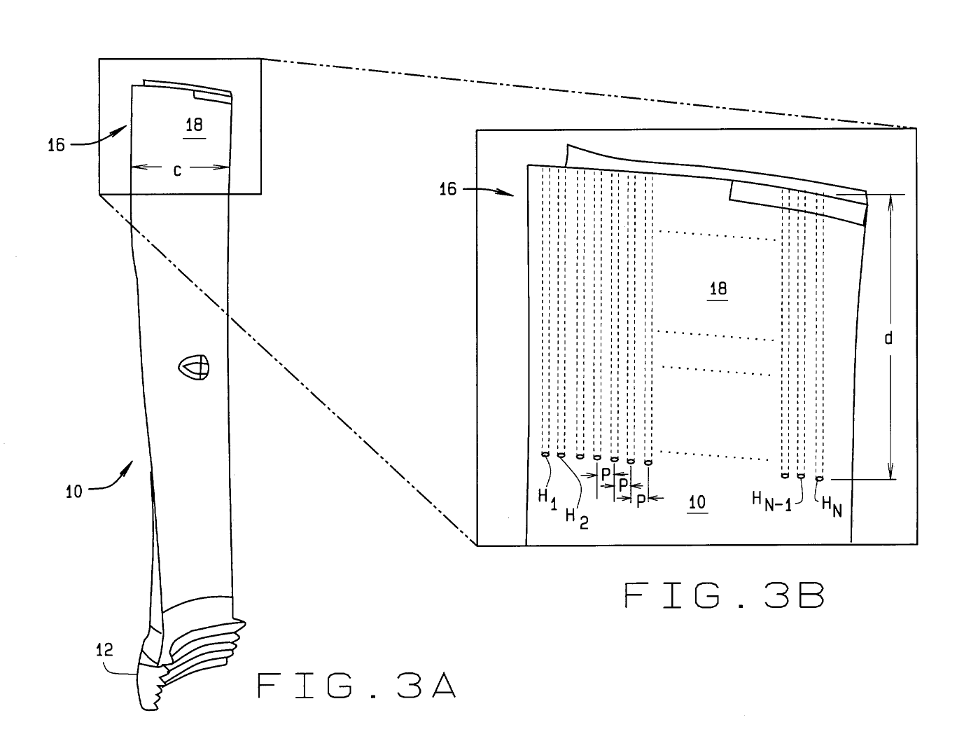

The blade or “bucket” as it is referred to in the art, first has a base 12 by which the blade is attached to a hub of the turbine. As is well known in the art, a dovetail attachment mechanism is used to secure the base of the blade to the hub. Blade 10 extends radially outwardly from the hub, from proximal base end 12 of the blade to a distal, tip end 16 thereof. As shown in FIGS. 2 and 3A, blade 10 has an arcuate contour the curvature of which is a function of the particular turbine design in which the blade is used. The particular geometry of blade 10 forms no part of this invention. It will be appreciated that the turbine stage is comprised of a plurality of blades 10 each of which are identically formed and each of which is mounted to the hub for common rotation. As shown in FIG. 2, the blades spin within a housing G which partly defines the last stage of the turbine.

In accordance with the invention, at least one, and preferably a plurality of holes H1-Hn are formed at the outer, tip end of blade 10. The holes extend inwardly from the end of the blade into a body 18 of the blade. Each hole extends inwardly a predetermined distance d which is, for example, 3-4 inches (7.6-11.1 cm). As shown in FIG. 3B, the depth of the holes is uniform as is a spacing P between the holes. The holes are spaced across a chord C of the blade at predetermined intervals with the number of holes and their spacing being determined by a number of factors.

These include, for example, the desired mass of the blade. It will be understood that the mass of the blade is a function of the design of the blade which, in turn, is determined by the particular steam turbine application. A second factor is local stress patterns (stress concentrations) which occur throughout the length of the blade and which are particularly important at the tip end of the blade. It is important that the hole locations and their spacing be such as to not increase stress concentrations, or else the blade may fracture at its tip and severely damage the turbine. A third and interrelated factor is the range of speeds over which the turbine operates. As noted in the Background section of the Specification, a normal range of speeds is 3000-3600 rpm; however, some turbines operate at higher or lower speeds. Other factors which come into consideration include vibrations to which the blade is subjected, and any resonant frequencies which are created within the turbine stage.

Depending upon the particular steam turbine application, all of the holes H1-Hn can be of the same depth, or some holes can be deeper than others. The holes can be of a uniform diameter throughout their length, or their diameter can taper from the outer to the inner end of the hole, and the diameter may vary between holes. In some applications, the spacing P between holes is uniform as shown in FIG. 3B; while in other applications, the spacing between holes, or groupings of holes, may vary across the chord of the bucket. Accordingly, those skilled in the art will understand that the holes H1-Hn shown in the drawings are representative only, and that other hole patterns and constructions are possible without departing from the scope of the invention. An important factor, regardless of the number of holes, how they are formed, and their spacing, is maintaining a minimum wall thickness between each hole and the sides S1, S2 of blade 10.

A variety of manufacturing processes; for example, electrical discharge machining, are available to create the holes during manufacture of the buckets.

The advantage of the holes H1-Hn is that they reduce the mass of blade 10 and lessen those forces to which the blade is subjected during turbine operation. Significantly, by locating the holes at tip end 16 of the blade, rather than at the base of the blade, the stress levels to which the entire body of the blade are subjected are reduced, enabling the root of the blade to now be thinner than with previous blade constructions. This further reduces the mass of the blade, and because less material is now required to make the blade, reduces aerodynamic blockage within the turbine, and improves turbine performance. Also, a blade having a thinner base now allows design configurations not previously possible to be implemented.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. In a blade (10) for use in the last stage of a steam turbine, the blade having a base (12) by which the blade is attached to a hub (H) for the blade to extend radially outwardly from the hub from the proximal base end of the blade to a distal, tip end (16) thereof, the improvement comprising a least one hole (H1) extending inwardly from the tip end of the blade into a body (18) of the blade a predetermined distance, thereby to reduce the mass of the blade at its tip end and lessen the forces to which the blade is subjected when the blade is rotating.

2. The improvement of claim 1 further including a plurality of holes (H1-Hn) formed in the tip end of the blade to further reduce the mass of the blade.

3. The improvement of claim 2 in which the holes are spaced across a chord (C) of the blade at predetermined intervals, the number of holes and their spacing being a function of the desired mass of the blade, local stress patterns formed at the tip end of the blade, the range of operating speeds of the turbine, vibrations to which the blade is subjected, and resonant frequencies created within the turbine stage.

4. The improvement of claim 3 in which each blade forming the last stage of the turbine has holes formed in the tip end thereof to reduce the mass of the respective blades.

5. The improvement of claim 3 in which each hole has a predetermined length to hole diameter ratio.

6. The improvement of claim 5 wherein the diameter of each hole is substantially constant along the length of the hole.

7. The improvement of claim 3 in which the diameter of each hole and the spacing between holes is further a function of a minimum wall thickness between the hole and sides (S1, S2) of the blade.

8. The improvement of claim 3 in which the diameter of each hole is of varying diameter.

9. The improvement of claim 8 in which the diameter of each hole and the spacing between holes is further a function of a minimum wall thickness between the hole and sides (S1, S2) of the blade.

10. The improvement of claim 2 in which the amount of mass of the blade reduced by the holes further allows the thickness of the blade, at the base end of the blade, to also be reduced.

11. A blade (10) for use in a steam turbine comprising:
a base (12) for attaching the blade to a hub (H) for the blade to extend radially outwardly from the hub from the proximal base end of the blade to a distal, tip end (16) thereof; and,
a plurality of holes (H1-Hn) extending inwardly from the tip end of the blade into a body (18) of the blade a predetermined distance, the holes being spaced across a chord (C) of the blade at predetermined intervals with the number of holes and their spacing being a function of the desired mass of the blade, local stress patterns formed at the tip end of the blade, the range of operating speed of the turbine, vibrations to which the blade is subjected, and resonant frequencies created within the turbine stage, the holes reducing the mass of the blade at its tip end thereby-to lessen the forces to which the blade is subjected when the blade is rotating.

12. The improvement of claim 11 in which the blade forms a last stage of the turbine.

13. The improvement of claim 12 in which the last stage of the turbine is comprised of a plurality of blades each of which has holes formed in the tip end thereof to reduce the mass of the respective blade.

14. The improvement of claim 11 in which each hole has a predetermined length to hole diameter ratio.

15. The improvement of claim 14 wherein the diameter of the holes are substantially constant along the length of the hole.

16. The improvement of claim 14 wherein the diameter of the holes taper along their length.

17. The improvement of claim 12 in which the diameter of each hole and the spacing between holes is further a function of a minimum wall thickness between the hole and sides (S1, S2) of the blade.

18. The improvement of claim 17 in which the amount of mass of the blade reduced by the holes allows the thickness of the blade, at the base end of the blade, to be reduced.

19. The improvement of claim 12 in which the diameter of each hole is of varying diameter.

20. The improvement of claim 19 in which the diameter of each hole and the spacing between holes is further a function of a minimum wall thickness between the hole and sides (S1, S2) of the blade.
